(19) United States
(12) Patent Application Publication
(10) Pub. No.: US 2024/0374467 A1
(43) Pub. Date: Nov. 14, 2024

(54) PENETRATION DETECTING CAP FOR MASTURBATION DEVICE

(71) Applicant: Vivien Cambridge, Myrtle Beach, SC (US)

(72) Inventor: Vivien Cambridge, Myrtle Beach, SC (US)

(21) Appl. No.: 18/580,724

(22) PCT Filed: Jul. 18, 2022
(86) PCT No.: PCT/US2022/037427

§ 371 Date: Jan. 19, 2024

(51) Int. Cl. A61H 19/00

(52) U.S. Cl. CPC A61H 19/34; A61H 2201/5058

(57) ABSTRACT

The present disclosure is directed to a penetration detecting cap device for removable attachment to a masturbation device. The cap device comprises a data sensing component for sensing data related to penetration of the masturbation device. In one embodiment, the data sensing component is a pressure detecting component and further comprises a seal adapting the cap to the housing of a masturbation device so that pressure in the cap relates to pressure inside the housing of the masturbation device, which is related to the degree of penetration into the masturbation device. The cap can be separated from the housing of the masturbation device with a flexible diaphragm so that pressure fluctuations inside the housing of the masturbation device are translated to the cap while fluids in the masturbation device are excluded from the cap.

### INCORPORATION BY REFERENCE

The following document is incorporated herein by reference in its entirety as if fully set forth herein: U.S. Provisional Patent Application 63/223,260, filed on Jul. 19, 2021.

### FIELD OF INVENTION

The present application relates to devices and methods for masturbation, and in particular to the detection and tracking of penetration of a handheld masturbation device.

### BACKGROUND

The benefits of masturbation for the human mind and body are well-documented. These include, among other things, the relief of stress, possible prevention of cervical and urinary tract infections and prostate cancer, improved cardiovascular health, reduced risk of type 2 diabetes, reduction in insomnia, and other benefits. The use of hand-held masturbatory implements are well known, and can include soft flesh-like rubber. These devices can be made to resemble the sexual organs of a sexual partner.

Many existing male masturbation devices can include an outer shell, as generally described in U.S. Pat. Nos. 5,782,818 and 5,807,360. These devices include an elastomeric gel that resembles human flesh and is molded to resemble various human orifices. The gel is inserted into a hard shell which serves to allow easier grasping of the device and also helps conceal the molded gel material. The hard shell usually includes at least one opening for access to the gel and at least one cap to close the opening when it is not in use. Many existing devices include one opening on a side opposite to the molded orifice that will be penetrated. This rear opening is used for exhaust of air and for cleaning. The devices can also include a cap for the rear opening to conceal the gel and generally to close and secure the device. The rear cap usually comprises screw threading to allow quick attachment and detachment to the shelled masturbating device.

Erotic games, such as computer games, can be used in conjunction with masturbation devices. In these games, a user can interact with characters via a masturbation device. These games can be played on computers or mobile devices, and the associated processors in these devices can be linked or connected with the masturbation device through a data connection. In other instances, a masturbation device may be connected to a remote masturbation device where physical actions of the user of the masturbation device result in actuation of a connected device for mutual interactive play.

To facilitate the detection and modulation of data related to masturbation, masturbation devices may include sensors which detect movement of the device relative to the penis. For example, these sensors may be accelerometers or gyroscopes that generate data when the masturbation device moves. Such devices generally detect movement rather than penetration of the device.

A device that detects penetration directly generally records pressure, capacitance or force fluctuations within the hull of the device. Unlike movement sensors, a device that directly measures penetration must include sensors in an environment where there are fluids and that must regularly be cleaned with water. The most direct measurement of penetration in the masturbation device measures fluctuation in pressure that results when a phallic object enters the opening in the elastomeric gel. Sensors in self-contained handheld masturbation devices that measure the pressure inside the hull of the masturbation device must be in contact with the air in the masturbation device. This complicates the sensing process and increases cost and complexity.

There is a need for a device that can be removably attached to a masturbation device which detects pressure fluctuations inside the masturbation device and uses sensing means that are shielded from fluids so that the masturbation device can easily be cleaned without damaging the associated sensors. This would be desirable in order to convert standard inexpensive masturbation devices to devices that are capable of interactive use.

The majority of masturbation devices on the market do not include the capability of detecting action, such as strokes or penetration, for use in games and for transmission to connected interactive devices.

There is currently no device that quickly and easily allows a user to convert a non-sensing masturbation device, such as those described, to a device that is capable of detecting the penetration by a user and modulating that action into data for use in computer applications, and that can be easily removed such that the masturbation device can be safely cleaned in water.

### SUMMARY

According to a first aspect, the present application is directed to a modified, pressure sensing cap which is configured to be selectively attached to a shell of a non-sensing masturbation device (i.e. a standard, inexpensive masturbation device with no integrated sensing features).

The cap can comprise a flexible diaphragm which deforms when the pressure in a hull or interior of the masturbation device changes. The deformation of the diaphragm causes fluctuation of pressure inside the cap, and this fluctuation is related to pressure inside the hull or interior of the masturbation device. The diaphragm can form a seal to protect against and serve as a barrier from fluids within the masturbation device.

The cap can include sensing features or sensors configured to detect and modulate pressure detected inside the cap. The present disclosure furthermore includes a latching or attachment feature for rapidly attaching and detaching the cap to a masturbation device. The latching feature can provide an airtight seal between the masturbation device and the cap. When a user penetrates the elastomeric gel of the masturbation device, the volume of air in the masturbation device will be reduced thereby resulting in an increase in the pressure inside the masturbation device. This increase in pressure causes deformation of the diaphragm and hence an increase in pressure inside the cap. The pressure inside the cap can be detected by a pressure sensor and transmitted to a processor. Therefore, the combined cap and masturbation device forms a penetration sensing masturbation device. The device disclosed herein can furthermore include a feedback element, which can include LED lights that are configured to be illuminated when penetration into the masturbation device is detected.

According to another aspect of the present disclosure, a capacitance sensing cap can also be configured to be selectively attached to a masturbation device. The cap can include a housing wall which forms a seal to protect from fluids inside the hull or interior of the masturbation device. The cap can include a capacitor which can be configured to generate or project an electric field into the hull, housing, or shell of the masturbation device. The cap can include a sensor or measurement element configured to detect or measure any disturbance in the electric field generated by the capacitor into the hull of the masturbation device. In this configuration, at least part of the elastomeric gel inside the hull of the masturbation device is modified to increase its dielectric quality, i.e. its ability to conduct, so that movement of the elastomeric gel and of the user's body inside the elastomeric get disturbs or disrupts the capacitance inside the hull, which is detected by at least one sensor inside the cap. In this configuration, a latching or attachment element can also be provided for quickly attaching and detaching the cap to a masturbation device such that the latching element provides an airtight seal between the masturbation device and the cap. When a user penetrates the elastomeric gel of the masturbator, the movement of the conductive elastomeric gel and of the user's body inside the conductive elastomeric gel causes fluctuations in the capacitance inside the hull of the masturbation device. This fluctuation in capacitance is detected by the capacitance sensor in the cap and transmitted to a processor. Therefore, the combined cap and masturbation device form a penetration sensing masturbation device. This configuration of the cap can also include feedback elements, such as light emitting diodes (LEDs), which are illuminated when penetration into the masturbation device is detected.

In another example, a cap is provided that is configured to be attached to a masturbation device. The cap includes at least one attachment element configured to selectively engage with the masturbation device. At least one sealing element is provided that is configured to provide a barrier relative to an interior of the masturbation device. At least one sensor is provided that is configured to detect penetration of the masturbation device.

The cap can include a processor configured to receive signals from the sensor regarding penetration of the masturbation device. The cap can also include an indicator element configured to be activated based on the signals from the processor. The indicator element can include a plurality of light emitting diodes (LEDs).

The attachment element can comprise a threading configured to matingly engage with corresponding threading on the masturbation device. The attachment element can include a flexible lip configured to engage a housing of the masturbation device, in another example.

The sensor can be a pressure sensor, a capacitance sensor or any other type of sensor.

The sealing element can be a flexible diaphragm, and the pressure sensor can be configured to detect penetration of the masturbation device based on fluctuations of the flexible diaphragm. In one example, the masturbation device includes a conductive elastomeric gel insert within an outer housing.

The cap can further include a rechargeable battery, in one example.

The cap can be configured to transmit signals regarding penetration of the masturbation device such that the signals are used to actuate a secondary phallic masturbation device.

In another aspect, a cap configured to be attached to a masturbation device is also disclosed that includes at least one attachment element configured to selectively engage with the masturbation device such that the cap can be attached and detached from the masturbation device, at least one sealing element configured to provide a barrier relative to an interior of the masturbation device, at least one sensor configured to detect penetration of the masturbation device, at least one processor configured to receive signals from the at least one sensor regarding penetration of the masturbation device, at least one indicator element configured to be activated based on signals from the at least one sensor, and a battery configured to power the at least one sensor, the at least one processor, and the at least one indicator element.

The at least one sensor can be a pressure sensor that is configured to detect pressure fluctuations within the masturbation device based on penetration of the masturbation device. In another aspect, the at least one sensor can be a capacitance sensor configured to detect capacitance fluctuations based on penetration of the masturbation device.

The at least one attachment element can comprise a threading configured to matingly engage with corresponding threading on the masturbation device. The at least attachment element can comprise a flexible lip configured to engage a housing of the masturbation device.

The at least one processor can be configured to wirelessly transmit data to a secondary processor, and the secondary processor can be configured to drive a secondary phallic masturbation device based on the signals from the at least one sensor. The at least one indicator element includes a plurality of LEDs.

A method of converting a non-sensing masturbation device to a sensing masturbation device is also disclosed herein.

Other embodiments and features are disclosed herein.

### BRIEF DESCRIPTION OF THE DRAWINGS

A more detailed understanding may be had from the following description, given by way of example in conjunction with the accompanying drawings wherein:

FIG. 1 is a perspective view of a masturbation device including a cap according to one aspect.

FIG. 2 is a side view of a masturbation device according to one example.

FIG. 3 is a cross-sectional view of a masturbation device according to one example.

FIG. 4A is a perspective view of a masturbation device with a cap attached according to one example.

FIG. 4B is a perspective view of the masturbation device with the cap detached.

FIG. 5A is a cross-sectional view of a cap according to one example.

FIG. 5B is a cross-sectional view of a cap attached to a masturbation device according to one example.

FIG. 5C is a magnified cross-sectional view of the cap and masturbation device of FIG. 5B.

FIGS. 6A-6E illustrate various states of use of the cap within a system according to one example.

FIG. 7 is a cross-sectional view of a cap and a masturbation device according to one example.

FIG. 8 is a flowchart showing steps according to a process associated with the cap according to one example.

FIG. 9 is a cross-sectional view of a cap according to one example.

FIGS. 10A-10E illustrate various states of use of the cap within a system according to one example.

FIG. 11 is a cross-sectional view of a cap and a masturbation device according to one example.

FIG. 12A is a cross-sectional view showing a first state of the cap according to one example.

FIG. 12B is a cross-sectional view showing a second state of the cap according to one example.

FIG. 13 is a flowchart showing steps according to a process associated with the cap according to one example.

FIG. 14 is a schematic illustration showing a system including the cap according to one example.

### DETAILED DESCRIPTION OF THE PREFERRED EMBODIMENTS

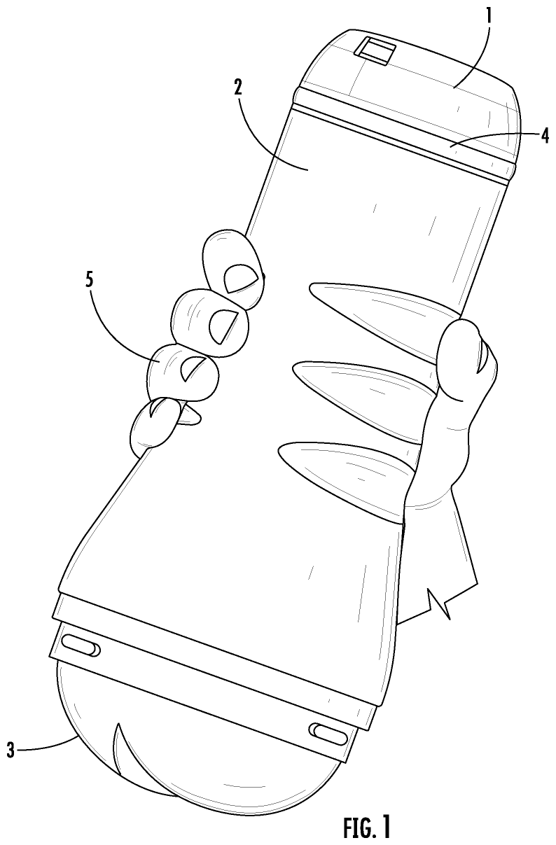

As shown in FIG. 1, in one aspect, the present disclosure is directed to a cap 1 that can be attached to a masturbation device including a shell 2 (also referred to as a housing, hull, casing, etc.) that is configured to be held by a user's hand 5. The masturbation device can include an elastomeric gel insert 3 inside of the shell 2. The elastomeric gel insert 3 can be configured to receive and accommodate a portion of a user's body, such as a user's penis during masturbation.

The cap 1 can be a pressure sensing cap and can be configured to be removably attached to the shell 2. The cap 1 can be configured to detect pressure fluctuations inside the shell 2. These pressure fluctuations can be related to or correspond to a degree of penetration of the male sex organ into the elastomeric gel 3, for example.

The cap 1 can include an indicator, which can be a visual indicator, sound indicator, haptic indicator, etc. In one example, the indicator 4 is includes at least one LED, which is configured to be illuminated when penetration is detected by the cap 1. For example, the indicator 4 can be activated if a specific degree of penetration is detected. A threshold penetration value can be set, which can be based on the depth of penetration or penetrative force.

Based on the features and cap 1 disclosed herein, a simple, inexpensive and non-sensing masturbation device can be converted to a more complex, sensing, and interactive masturbation device based on the use of the cap 1.

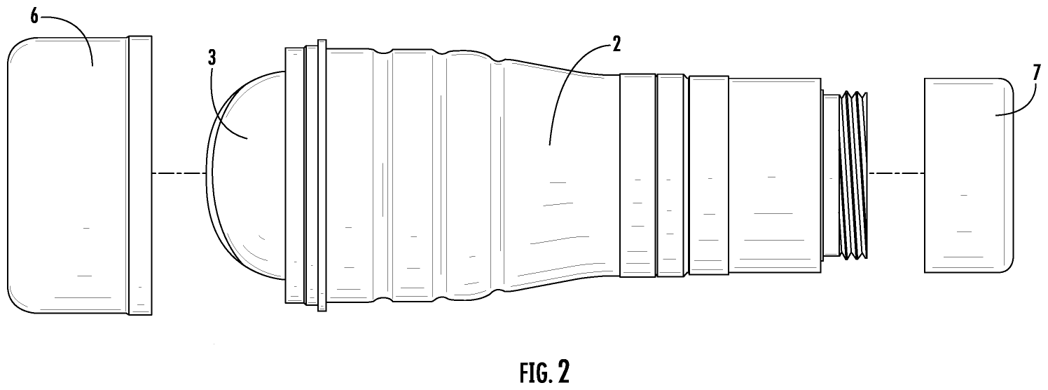

FIG. 2 illustrates one type of masturbation device. As shown in FIG. 2, the masturbation device can include an elastomeric gel insert 3 contained within a shell 2 that is closed on either side by caps 6, 7. For example, a first cap 6, i.e. front cap, can be configured to engage with the shell 2 and protect and conceal the elastomeric gel insert 3. A second cap 7, i.e. rear cap, can be configured to be attached to the shell 2 and close a rear end of the shell 2. The second cap 7 can be removed such that the interior can be cleaned, rinsed, or otherwise accessed by the user.

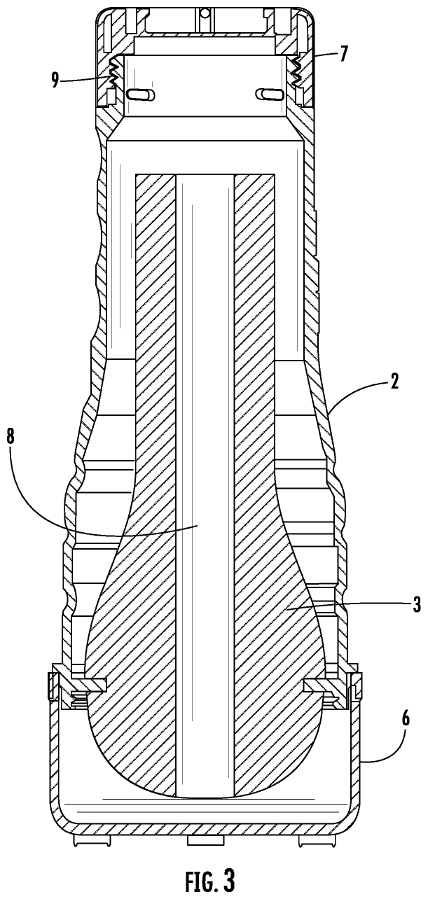

FIG. 3 illustrates further details inside of the shell 2 of the masturbation device. As shown in FIG. 3, the cap 7 can be attached to the shell 2 via threading 9 formed on the shell 2. The other cap 6 can also be attached to the shell 2 via threading or via a snap fit connection. An interior channel or orifice 8 is defined by the elastomeric gel insert 3.

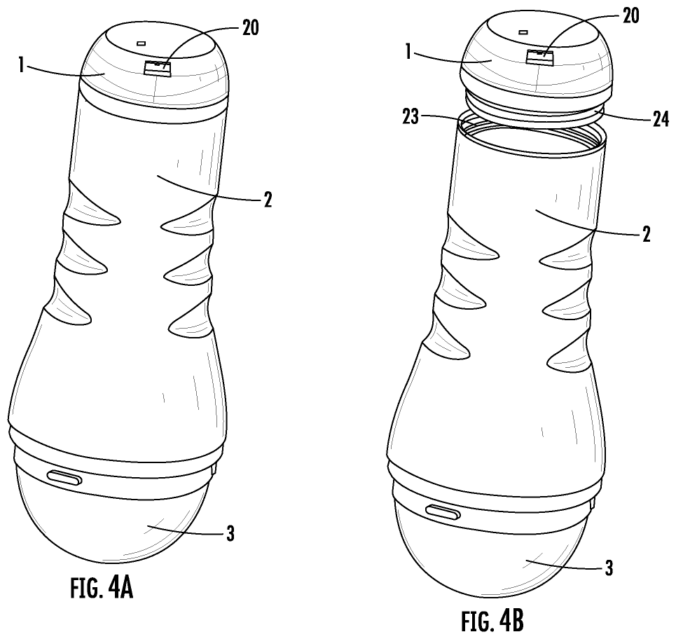

FIG. 4A illustrates a perspective view of a masturbation device with the cap 1 attached while FIG. 4B shows the masturbation device with the cap 1 detached. As shown in FIGS. 4A and 4B, the cap 1 is configured to be attached to the shell 2. In one example, the cap 1 is configured to be attached to the shell 2 via threading 24 formed on an end of the cap 1. The threading 24 of the cap 1, which is also referred to herein as an attachment element, can be configured to engage with threading 23 formed on the shell 2. For example, the threading 23 can be formed on an interior surface of the shell 2 on an end of the shell 2. One of ordinary skill in the art would understand that the connection between the cap 1 and the shell 2 can be achieved in a variety of ways. For example, various snap fit connectors, latches, positive fit connectors, etc. could be used to connect the cap 1 to the shell 2. FIGS. 4A and 4B also show a knob 20, which can be any type of actuator configured to toggle modes for the cap 1, or turn the cap 1 on and off. One of ordinary skill in the art would understand that the cap 1 can be attached to the masturbation device via a press-fit, interference-fit, or any other fitting.

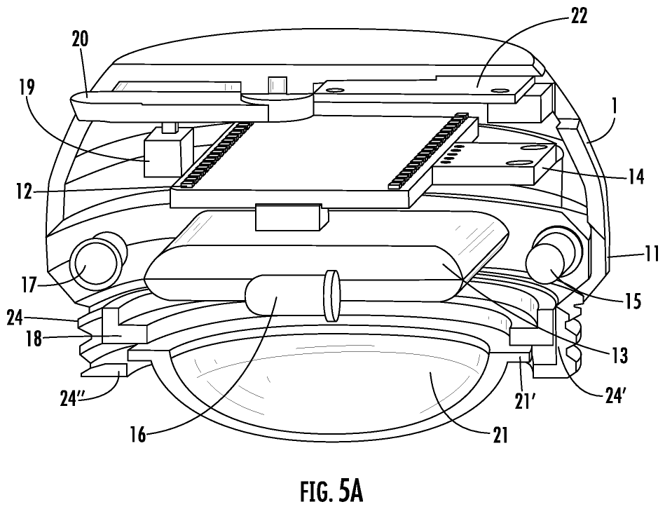

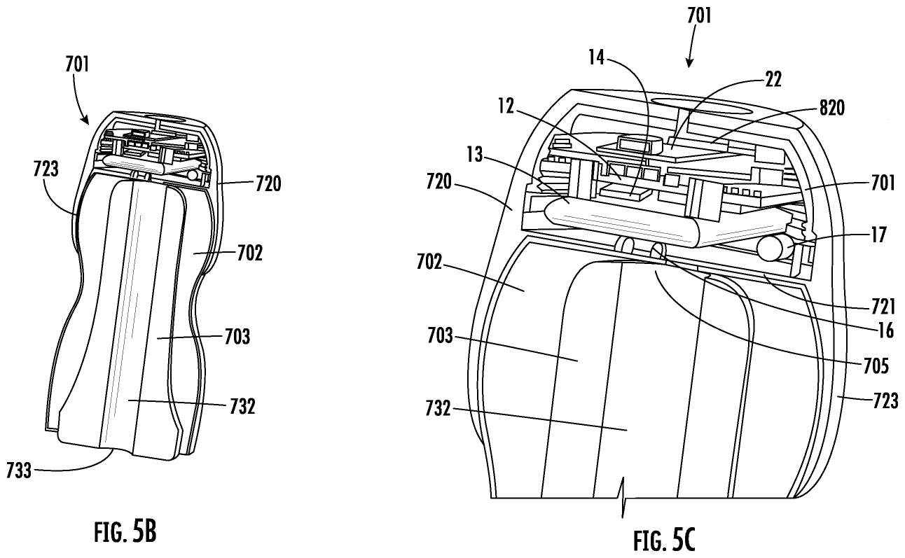

FIG. 5A shows various internal components of the cap 1. As shown in FIG. 5A, the cap 1 can include a flexible diaphragm 21. The flexible diaphragm 21 can be arranged on a side of the cap 1 that includes the threading 24. The flexible diaphragm 21 can be arranged on a bottom side of the cap 1 that generally faces the masturbation device when the cap 1 is attached. The flexible diaphragm 21 can be configured to protect against liquids from within shell 2 of the masturbation device from entering the interior space of the cap 1. The flexible diaphragm 21 can be formed from rubber or another material capable of elastically deforming. An edge of the flexible diaphragm 21 can be secured around a periphery of an internal surface of the cap 1. A remainder of interior of the cap 1 can be sealed such that a specific volume is provided within the cap 1. The flexible diaphragm 21 can have a dome-shaped profile, as shown in FIG. 5A. In one configuration, the dome-shaped profile is convex (i.e. bows outward from the cap 1). The flexible diaphragm 21 can provide a liquid-proof seal such that the interior of the cap 1 is protected, particularly relative to materials, fluids, or other contaminants from the masturbation device. The cap 1 can otherwise be open to the environment in a portion or region of the cap 1 away from the end of the cap 1 that is attached to the masturbation device such that volume of air within the interior of the cap 1 is variable based on the pressure fluctuations.

The flexible diaphragm 21 is configured to allow for the transfer of pressure fluctuations from the shell 2 to the cap 1. The cap 1 can include a sensor 14. In one aspect, the sensor 14 can be a pressure sensor that is configured to detect pressure fluctuations that are associated with penetration of the user's body into the elastomeric gel insert 3 in the shell 2. The diaphragm 21 can be configured to be held in place by a container ring 18. The container ring 18 can include an outer periphery that is configured to be press fit against an inner surface of the cap 1 on an end including the threading 24. As shown in FIG. 5A, an interior surface 24′ of the threading 24 can define a support surface for the container ring 18. The container ring 18 can have an L-shaped profile when viewed in cross-section. A radial extension of the container ring 18 can define a support surface for the flexible diaphragm 21, and an axial extension of the flexible diaphragm 21 can define an abutment surface for engaging with the interior surface 24′ of the threading 24. The flexible diaphragm 21 can include a securing lip or edge 21′ that is configured to be gripped between the container ring 18 and an edge 24″ of the threading 24. The securing lip or edge 21′ can extend in a radial direction. The container ring 18 can define a central opening or hole that defines a channel between the flexible diaphragm 21 and the interior of the cap 1.

A processor 12 can be connected to the pressure sensor 14 and the processor 12 can be configured to modulate pressure measurements and transmit data, such as pressure measurement data, to a computer, processor, or other component. The processor 12 and the pressure sensor 14 can be energized or powered via a battery 13. The battery 13 can be configured to be charged via a charging component 22. The processor 12 can be connected to the battery 13 via a power switch 19, which can be turned on and off via an actuator, such as a knob 20. In one configuration, when a pressure related parameter exceeds a threshold value, then the processor 12 causes LEDs 15, 16, 17 to be illuminated. The LEDs 15, 16, 17 can be part of the indicator 4. The LEDs 15, 16, 17 can be arranged in side of a window 11, which can be transparent, such that the LEDs 15, 16, 17 can provide some visual indication to a user.

FIGS. 5B and 5C illustrate another aspect of a cap 701 including a housing 720. As shown in FIGS. 5B and 5C, the cap 701 can include an attachment element that is configured to engage with the masturbation device. The attachment element can be formed as an extension, such as a sleeve or cantilevered element, from a base portion of the housing 720. The attachment element can be a flexible attachment element 723, such as a flexible fastener skirt, that is configured to attach the cap 701 to a housing 702 of a masturbation device. This arrangement allows for the cap 701 to attach to a masturbation device that does not include any threading or fastening component, and instead the cap 701 can attach to a smooth outer housing of a masturbation device. Additionally, the flexible attachment element 723 can attach to housings of masturbation devices of varying sizes and diameters. The attachment element 723 can be formed from a semi-rigid plastic, in one example.

The masturbation device can include a hole 705 configured to allow air to escape the housing 702 when the elastomeric gel insert 703 is penetrated, such as via a through opening 733 into an orifice 732. The cap 701 can include a flexible diaphragm 721 which protects against liquids from within the housing 702 from entering into the internal components of the cap 701. The flexible diaphragm 721 is configured to allow for the transfer of pressure fluctuations from the housing 702 through the opening 705 to the cap 701 so that the pressure sensor 14 can detect pressure fluctuations which are related to penetration into the elastomeric gel insert 703 in the housing 702.

The processor 12 can be connected to the pressure sensor 14, which is configured to modulate pressure measurements and transmit pressure related data to a different processor, computer, or electrical component. The processor 12 and the pressure sensor 14 can be powered by a battery 13 which can be charged through a charger component 22. The charger component 22 can be configured to receive a charging plug or electrical plug that can provide power to the battery 13.

The processor 12 can be connected to the battery 13 through a power switch 19 which is configured to be turned on and off via a knob 820. When pressure related parameter exceeds a threshold value, then the processor 12 can send signals to illuminate LEDS 16, 17, which are visible through a partially transparent region or material of the cap 701. The cap 701 generally operates in the same manner as the cap 1 unless otherwise specified.

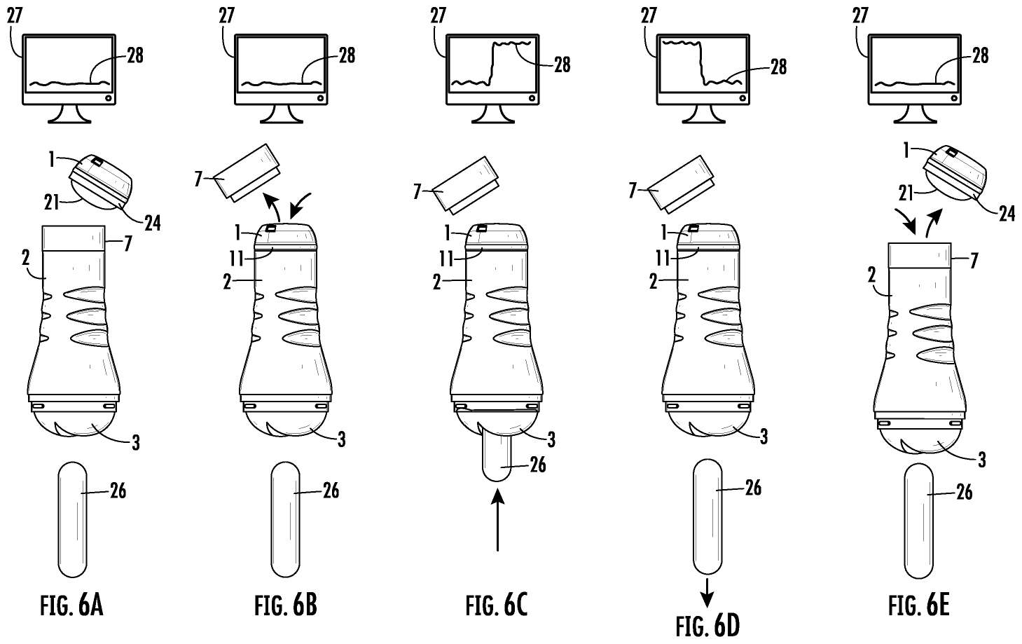

FIGS. 6A-6E illustrate various states of use of the cap 1. As shown in FIGS. 6A-6E, the cap 1 is shown in various states relative to a masturbation device. A phallic shaped object 26 is shown schematically in FIGS. 6A-6E with respect to relative positioning relative to a masturbation device. In FIG. 6A, a cap 7 (i.e. a simple, non-interactive cap) is attached to the shell or housing 2 of the masturbation device. The cap 7 can be removed, such as via twisting to disengage threading on the cap 7 from threading on the shell 2. As shown in FIG. 6B, the cap 7 is fully removed and the cap 1 is attached to the shell 2. The cap 1 is generally configured to generate data related to penetration of the masturbation device and this data can be sent to a processor for further processing. For example, the data can be tracked on a display or monitor 27, on which a graph 28 can be displayed that represents the penetrative action. In another example, this data can be used by a processor or computer to provide some corresponding motion or action of a virtual element or in a videogame. The graph 28 is shown in varying states throughout FIGS. 6A-6E, with FIGS. 6A, 6B, and 6E showing no activity and FIGS. 6C and 6D showing the penetrative activity visually on the graph 28. The graph 28 is only shown for illustrative purposes and one of ordinary skill in the art would understand that the data could be used in a variety of ways besides a graph 28.

When the phallic shaped object 26 enters the elastomeric gel insert 3 in FIG. 6C, the cap 1 is configured to record and modulate data related to pressure that is related to penetration of the cap 1. This data is transmitted to a processor, which is configured to show the graph 28. When the phallic shaped object 26 is withdrawn from elastomeric gel insert 3 in FIG. 6D, then the cap 1 records and transmits data which reflects this change. As shown in FIG. 6E, the cap 1 is fully removable from the shell 2, and the original cap 7 can be replaced onto the shell 2. Based on the ability to freely remove the cap 1 from the shell 2, the cap 1 provides the ability to selectively attach and detach the cap 1 from a simple masturbation device such that the simple masturbation device can be converted to a more complex masturbation device.

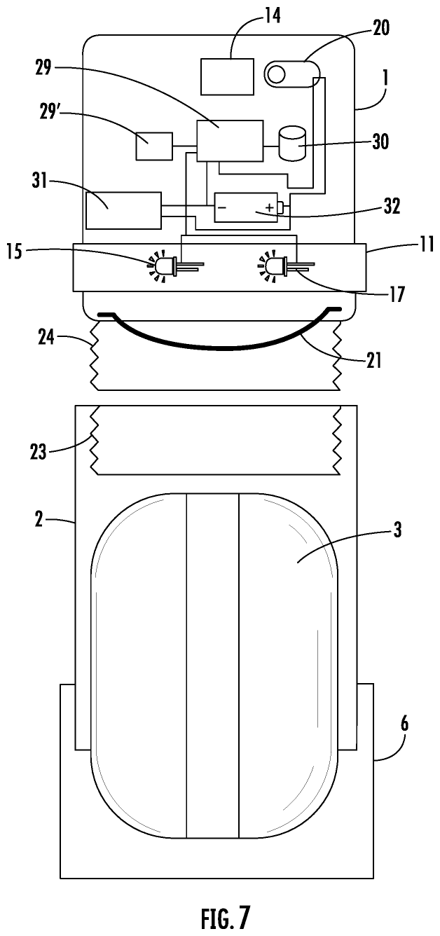

FIG. 7 illustrates additional components of the cap 1. As shown in FIG. 7, the shell 2 of the masturbation device can be closed or capped via a first cap 6, which can be configured to conceal and protect the elastomeric gel insert 3. The shell 2 can include a first threading 23 (i.e. female threading), and the cap 1 can include a second threading 24 (i.e. male threading).

The cap 1 can include at least one processor 29 that is configured to run software or other operating programs. A data storage unit 30 can be provided in the cap 1 that is configured to store data related to the usage of the cap 1 and other information. The processor 29 can be configured to process, modulate and transmit pressure related data that is detected by a sensor 14, i.e. a pressure sensor. This data can be transmitted to another processer, such as a host processor through a transmitter 29′. The transmitter 29′ can be configured to wirelessly transmit data to a receiving unit, processor, or other electrical component. The processor 29 can be powered by at least one battery 32, which can be rechargeable via a charging unit 31. The charging unit 31 can be configured to be charged via an electrical outlet or plug. When pressure related data is detected by the processor 29, then the processor 29 can be configured send signals such that indicators, i.e. LEDs 15, 17, are activated. The indicators can have variable settings such that a first state of penetration results in a first indication state, and a second, greater state of penetration results in a second indication state that is different than the first indication state. For example, the LEDs 15, 17 may turn green during shallow penetration of the device, and may turn red during deeper penetration of the device. The processor 29 can also be configured to send signals to any other type of indicator, such as an audible emitter, other visual indicator, tactile or haptic indicator, etc.

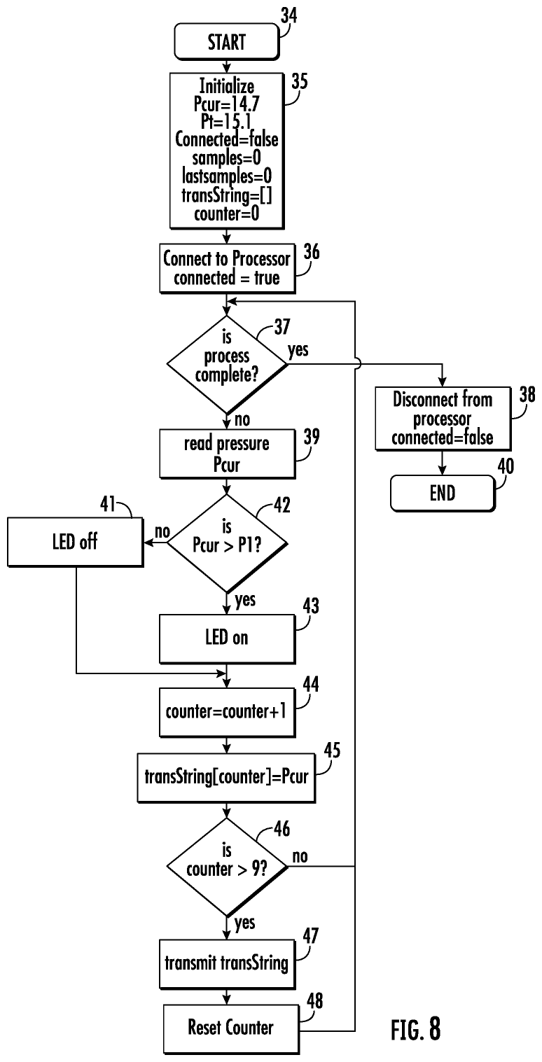

FIG. 8 illustrates one exemplary flow chart for a process according to the present disclosure. As shown in FIG. 8, the process can start at step 34. Step 35 next includes an initialization process. This step 35 can include initializing variables and other parameters. For example, step 35 can include the cap 1 detecting the current pressure within the cap 1, and automatically setting a threshold value for pressure that is greater than the current pressure. For example, the threshold pressure may be set to 1%-5% greater than the current pressure. This step 35 can include storing pressure data and data relating to the state of the cap 1 and system. For example, 14.7 pounds per square inch (psi) can be ambient pressure near sea level (i.e. a base level pressure value) and a threshold pressure of 15.1 psi can be the pressure above which penetration is indicated. One of ordinary skill in art would understand that these values will vary. Additionally, the cap 1 can have a calibration step in which the pressure sensor detects ambient pressure and sets this pressure value as a baseline pressure value, against which a current pressure is compared to in order to determine if penetration is occurring.

Step 36 can include connecting a processor in the cap 1 to another processor, such as a host processor which can be associated with videogame software or a remote user. This step can establish a communication network or channel with external components, processors, etc.

Step 37 can include determining whether the start-up or initialization process is complete. If the process is not complete, then the cap 1 is configured to detect the current pressure (i.e. Pcur) related parameter during step 39.

Step 42 includes determining if the current pressure related parameter exceeds a threshold (i.e. Pcur>Pt). If the current pressure related parameter does not exceed threshold pressure, then the indicator element or the LEDs are turned off at step 41. If the current pressure related parameter exceeds threshold pressure (i.e. indicating that penetration is occurring), then the indicator element or LEDs are turned on at step 43.

The process can be configured to increment a counter at step 44 (i.e. counter+1). The system can be configured to accrue a number of pressure readings in an array (i.e. array transP) and transmit the array when a number of elements in the array exceeds a predetermined value, such as 10.

Steps 45-48 can include composing a string array which comprises a series of pressure related variables. If the counter exceeds a predetermined value, such as nine, in step 46, then the process can be configured to transmit the array comprising the pressure related variables to a further processor or computer, such as a host computer, at step 47. The system can be configured to then reset the counter in step 48.

The process can then be configured to return to step 37 to continue the process, such that the entire process is iterative. If the process is complete, then step 38 can be initiated and disconnect the processor in the cap 1 from any external processor, computer, etc., and step 40 can terminate the process.

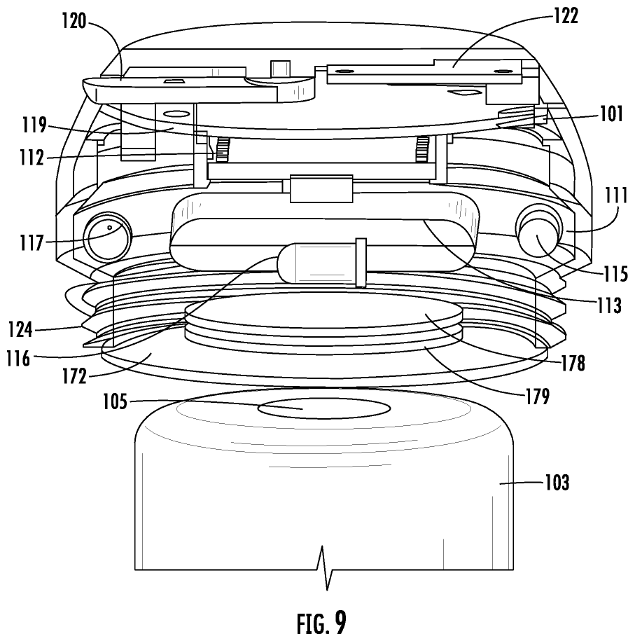

FIG. 9 is a cross-sectional view that illustrates a cap 101. As shown in FIG. 9, the cap 101 can include a threading 124 configured for attaching the cap 101 to a housing 2 of the masturbation device. The cap 101 can include a wall 172 or barrier which is configured to prevent the ingress of contaminants or liquid from the housing 2 to the interior of the cap 101. The wall 172 can be provided on a bottom side of the cap 101 that generally faces the masturbation device. The wall 172 can be configured to allow an electrical field to project into the housing 2 of the masturbation device from the cap 101 so that the processor 112 can detect fluctuations in capacitance related to the electrical field projecting into the housing 2. In one example, the wall 172 can be comprised of a material that generally exhibits low electromagnetic shielding such as acrylonitrile butadiene styrene (ABS) plastic. One of ordinary skill in the art would understand that other materials could be used. These fluctuations are related to penetration into the elastomeric gel insert 103. In one example, the elastomeric gel insert 103 can include carbon powder elements, such as via infusion of a carbon powder, which renders the elastomeric gel insert 103 to be conductive. Based on this arrangement, the deformation and displacement of the elastomeric gel insert 103 during insertion of a phallic-shaped object results in disturbance of capacitance or variation of capacitance as detected by processor 112. The elastomeric gel insert 103 can also include an opening 105 on its terminal end.

In one example, an electric field that projects into the housing 2 can be generated by a charged electrode 178 and a ground element 179. The processor 112 can be configured to modulate capacitance measurements and transmit capacitance related data to another computer or processor. The processor 112 can be powered by at least one battery 113 which can be rechargeable via a charging unit 122. The processor 112 can be configured to be connected to the battery 113 via a power switch 119 which can be turned on and off via a knob 120. When a pressure related parameter exceeds a threshold value, then the processor 112 causes LEDs 115, 116, 117 to be illuminated, which can be visible through a window 111.

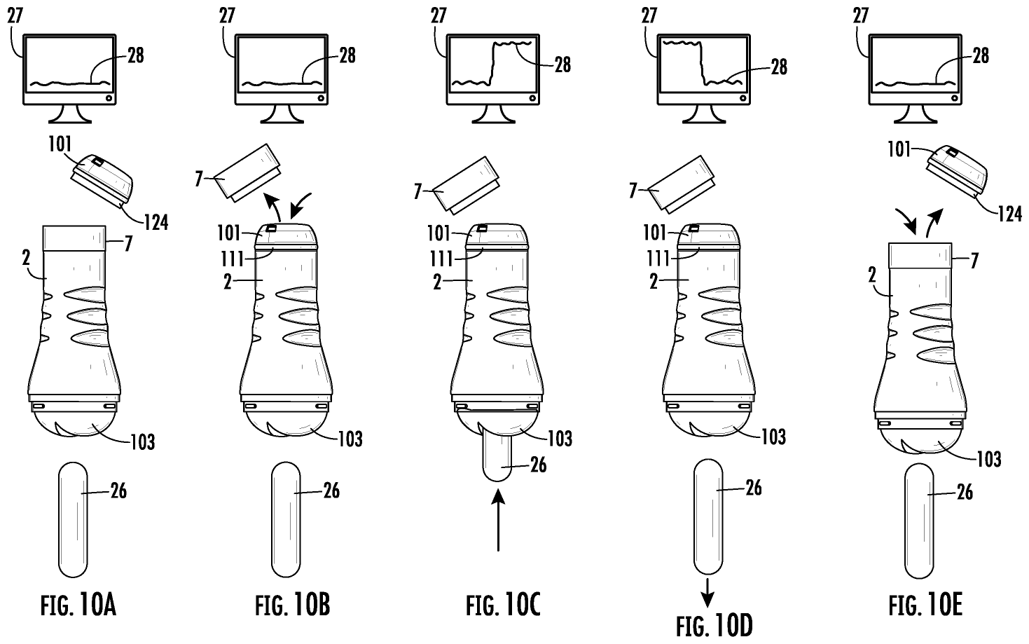

FIGS. 10A-10E illustrate various states of use for the cap 101, which are similar to FIGS. 6A-6E. Data related to penetration of the elastomeric gel insert 103 is detected by the cap 101 and transmitted to a processor for generating the graph 28 on a display unit or monitor 27. In FIG. 10A, the graph 28 shows pressure related data to be at a low level, or base level. In FIG. 10B, a simple, non-interactive cap 7 is removed and replaced with the cap 101 thereby rendering the masturbation device capable of detecting penetration. When the phallic shaped object 26 enters the elastomeric gel insert 103 in FIG. 10C, the cap 101 records and modulates data related to pressure related to penetration of the elastomeric gel insert 103. The cap 101 is configured to transmit this data to a processor which displays on the graph 28 on the monitor 27 to show the increase in penetration and the penetrative states. When the phallic object 26 is withdrawn from the elastomeric gel insert 3 in FIG. 10D, then the cap 101 records and transmits data which reflect this change. FIG. 10E illustrates that the cap 101 is configured to be removed from the housing 2 and replaced with the cap 7. Data collected by the cap 101 can be used to dynamically control, manipulate, move, or drive virtual elements or elements within a videogame. For example, a virtual element, such as a virtual character, may mimic movement or penetration based on the data or signals from the cap. Additionally, this data could be used to drive another sex toy.

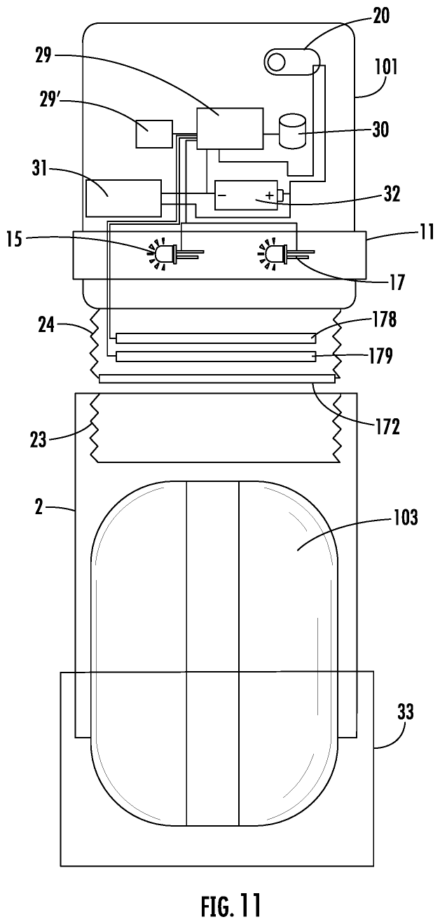

As shown in FIG. 11, the housing 2 of the masturbation device can be closed by a cap 33, which can be configured to conceal and protect the elastomeric gel insert 103. The housing 2 can include a first thread 23, i.e. female thread, which is configured to matingly engage with a second thread 24, i.e. male thread, formed on the cap 101. The cap 101 can include a wall 172 for excluding fluids from the housing 2 while fluctuations in capacitance fluctuations in the housing 2 are detected in the cap 101. The cap 101 can include a processor 29 that is configured to run, use, or otherwise implement software or other processing modules or programs, and that is configured to be connected to a storage unit 30.

The processor 29 can be configured to process, modulate and transmit capacitance related data to a further processor or computing unit through a transmitter 29′, which can be configured to transmit data or signals to other electrical components. The processor 29 can be powered by at least one battery 32, which can be rechargeable via a charging unit 31. When capacitance related data detected by the processor 29 exceeds a threshold value, the processor 29 can be triggered to cause the LEDs 15, 17 to be illuminated. All other components of cap 101 are otherwise similar to cap 1 unless specified herein.

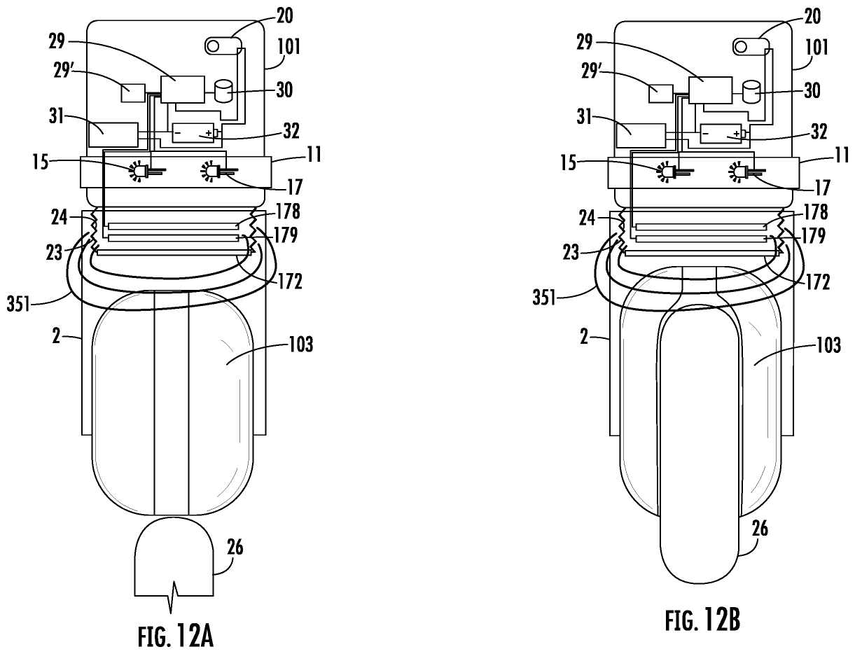

FIGS. 12A and 12B show the penetration sensing mechanism of the cap 101. As shown in FIG. 12A, the processor 29 can be configured to send a signal to an electrode 178 to be charged thereby creating an electric field 351 between the electrode 178 and a ground element 179. In one aspect of this example, sensing or detecting of penetration is achieved by detecting changes in capacitance as a field created by charged electrode 178 through ground electrode 179 which is disturbed by the penetrating object. The field 351 can be configured to project across the wall 172 into the housing 2 of the masturbation device. When the phallic-shaped object 26 penetrates the elastomeric gel insert 103, which can be infused with graphite, then the flesh of the phallic-shaped object 26 causes the elastomeric gel insert 103 to move thereby creating a fluctuation in the electric field 351 that is related to the degree of penetration of the phallic-shaped object 26 into the elastomeric gel insert 103. This fluctuation is detected by the processor 29 and the fluctuation in the electric field variable (i.e. capacitance) related to degree of penetration is processed, analyzed, and computed in the processor 29. This data can be further processed and transmitted to another computing device or processor.

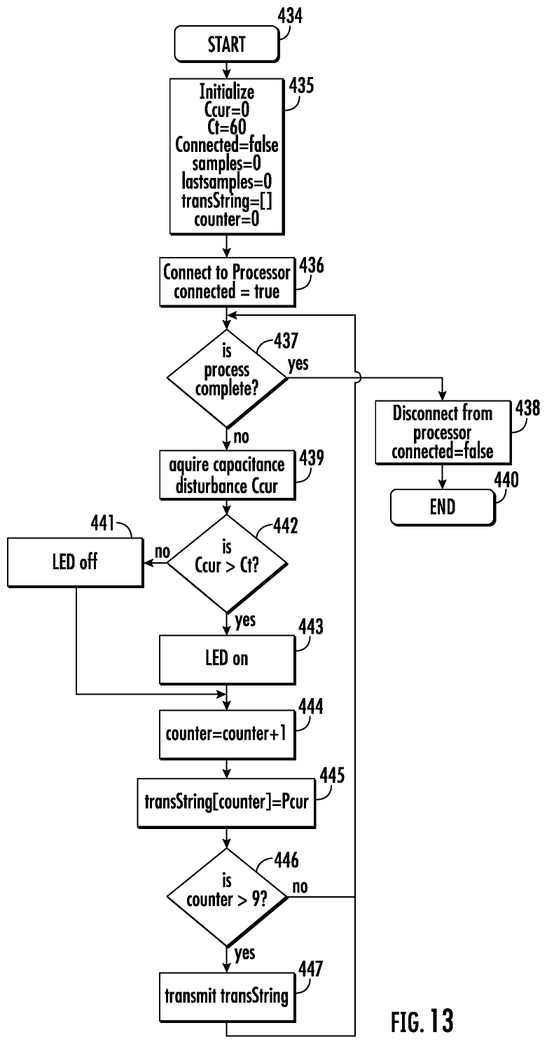

FIG. 13 shows a flow chart of another process. As shown in FIG. 13, the process can include step 434, i.e. a starting or powering up step. During step 435, an initialization step can be carried out in which the process initializes variables. The variables can be related to capacitance, for example. For example, a current capacitance can be detected and a threshold capacitance can be set. In one example, a base or resting capacitance can be 0 farad, and the threshold capacitance can be 60 farad. One of ordinary skill in the art would understand that these values can vary.

The process can include connecting to a host processor, computer, or other electronic component in step 436. Step 437 can include determining if the process in step 436 is complete. If the process is not complete, then the process detects the current capacitance (i.e. Ccur) related parameter during step 439. The process is configured to determine if a current capacitance related parameter exceeds a threshold at step 442 (i.e. Ccur>Ct). If the current capacitance related parameter does not exceed threshold value, then the indicator element or LEDs are turned off at step 441. One of ordinary skill in the art would understand that other indicators could be used besides LEDs. If a current capacitance related parameter exceeds a threshold value, then an indicator is activated, i.e. the LEDs are turned on, at step 443. The process can include an incremental step 444 in which an array, such as Ptrans, comprising pressure values is filled before this array (Ptrans) is transmitted. The counter increments to point to successive elements in the array that are filled with pressure values. When the counter value reaches a limit, such as 10, then the array can be transmitted. During step 445, the process can include composing a string array which comprises a series of capacitance related variables. If the counter in step 446 exceeds a predetermined value, i.e. number nine, which determines the size of the array of pressure values accumulated before the data is transmitted then the process at step 447 can include transmitting the array comprising capacitance related variables to another electrical component, such as a processor, computer, host computer, etc. Step 437 can be an iterative step in which the process continues. If the process is complete, then the process is configured to proceed to step 438 in which the cap and its processor can disconnect during step from an external or secondary processor, computer, host processor, etc., to end the process at step 440.

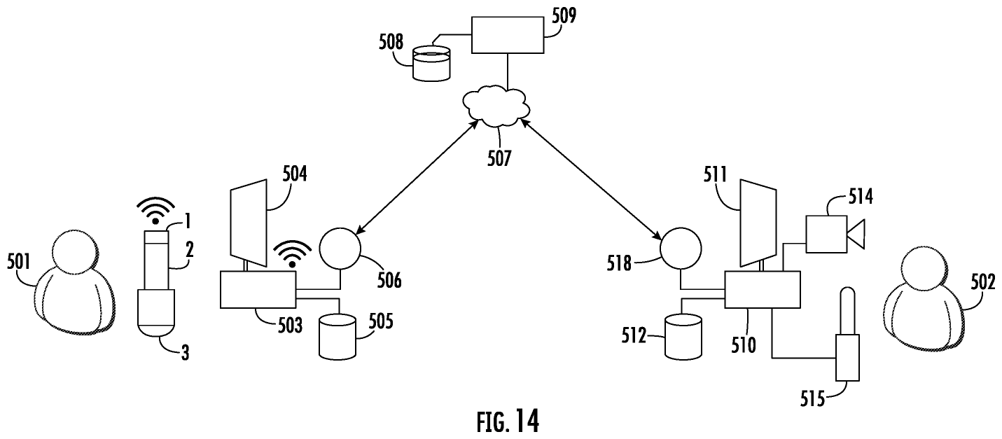

FIG. 14 illustrates a system in which the cap 1 can be used. As shown in FIG. 14, the cap 1 is attached to the housing 2 of a masturbation device which encloses the elastomeric gel insert 3. A first user 501 can use a masturbation device on which the cap 1 is arranged. The cap 1 is configured to generate data related to penetration of the masturbation device. Data from the cap 1 is configured to be transmitted to a computer 503, such as a host computer, which is configured to access software or programs. The computer 503 can be connected to a data storage unit 505 which can be configured to store software, including computer games, applications, or other software. Data can be transmitted and received via a communication module 506, which can be connected to a wireless network 507. A remote processor 509, i.e. cloud computing processor or computer, can be provided that is connected to the network 507. A remote data storage unit 508 can be provided in communication with the remote processor 509. A secondary communication module 513 can be provided that is also connected to the wireless network 507. The communication module 513 is connected to a secondary processor 510 which is configured to access software or other programming interfaces or elements that are configured to be stored in a data storage unit 512. The secondary processor 510 can be configured to provide a signal to a secondary masturbation device, such as a phallic masturbation device 515, which can be used by a second user 502. An image recording device 514, such as a video camera, can be provided for the second user 502 that is configured to send images of the second user 502 to a display device 504 used by the first user 501. The second user 502 can also have access to a display device 511. Within this system, the first and second users can be playing a videogame such that interaction with the cap 1 drives, directs, or otherwise controls the activity of virtual elements in the videogame. For example, a video game, gaming software, or other interactive user platform can be configured to match the frequency of strokes with which the user engages the device to the frequency of strokes exhibited in an associate virtual environment, such as an erotic animation depicting two actors in a given scene.

According to a first aspect, a cap is provided that is generally configured to be attached to a masturbation device. The cap can be selectively attached and removed from the masturbation device. The cap can include multiple features, such as an attachment element, which can be any mechanically fastening component or interface, such as a threading, a sleeve, or other attachment element. The attachment element is generally configured to be selectively engaged with the masturbation device, such as via an outer surface of a housing of the masturbation device or a via a threading formed on a terminal end of the masturbation device. The cap also includes a sealing element, such as impervious seal, diaphragm or other component. The sealing element can be formed as a domed shape, flexible component. The sealing element can be configured to protect elements within the cap from any fluids or other contaminants, such as electrical components, processors, sensors, batteries, etc. Within the cap, at least one sensor is disposed that is generally configured to detect penetration of the masturbation device. Detection of the penetration can occur based on pressure fluctuations, capacitance fluctuations, or other configurations.

According to a second aspect, the cap also comprises at least one processor configured to receive signals from the at least one sensor associated with penetration of the masturbation device.

According to a third aspect, the cap also comprises at least one indicator element configured to be activated based on the signals from the at least one processor.

According to a fourth aspect, the at least one indicator element can include a plurality of LEDs.

According to a fifth aspect, the at least one sensor is a pressure sensor.

According to a sixth aspect, the at least one sensor is a capacitance sensor.

According to a seventh aspect, the cap further comprises a rechargeable battery.

According an eighth aspect, the cap is configured to transmit signals regarding penetration of the masturbation device such that the signals are used to actuate a secondary phallic masturbation device.

According to a ninth aspect, the cap is configured to transmit signals regarding penetration of the masturbation device to a processor and the signals are used to control a virtual element.

According to a tenth aspect, a cap is provided that is configured to be attached to a masturbation device, and the cap comprises: (i) at least one attachment element configured to selectively engage with the masturbation device such that the cap can be attached and detached from the masturbation device; (ii) at least one sealing element configured to provide a barrier relative to an interior of the masturbation device; (iii) at least one sensor configured to detect penetration of the masturbation device; (iv) at least one processor configured to receive signals from the at least one sensor associated with penetration of the masturbation device; (v) at least one indicator element configured to be activated based on signals from the at least one sensor; and (vi) a battery configured to power at least the at least one sensor, the at least one processor, and the at least one indicator element.

Any one or more of the features described in the above aspects can be adapted to be used in any one or more of the other aspects.

A method of converting a non-sensing masturbation device into a sensing masturbation device is also disclosed herein. As used in this context, the term non-sensing masturbation device can refer to a masturbation device lacking any sensors and/or electronics. In one aspect, the masturbation device is a simple masturbation device including an outer housing or shell, and an interior soft sleeve having an opening configured to receive a user's body part. In one aspect, the masturbation device lacks any sensors configured to detect or determine if the sleeve of the masturbation device is being penetrated. The method includes accessing a portion of the masturbation device, such as a terminal end of the masturbation device. In one aspect, this access can be provided via removal of an end cap from the masturbation device. The method can include accessing an end of the masturbation device such that an opening is accessible that is in communication with an interior of the sleeve within the masturbation device. The method can include attaching the cap, as disclosed herein, to the masturbation device. The cap can be attached such that the cap is reliably secured with the masturbation device. Attaching the cap to the masturbation device can include twisting or rotating one of these components relative to the other. Attaching the cap to the masturbation device can alternatively include engaging a sleeve or flexible attachment skirt of the cap with the masturbation device. Regardless of the attachment method, once the cap is secured with the masturbation device, the cap can be activated (i.e. turned on). The cap includes, among other components, a sensor that is configured to detect a change in state based on penetration of the masturbation device. During use of the masturbation device, i.e. penetration, the cap is configured to detect a degree of penetration based on the sensor obtaining readings. For example, the sensor can be configured to detect pressure within the cap, which fluctuates based on penetration of the device. In another example, the sensor is configured to detect a capacitance value, which fluctuates based on penetration of the masturbation device. Regardless of the method of detection, the cap is configured to provide an output signal that is representative of the penetration of the masturbation device. This output signal can be used in a variety of ways, including but not limited to, in order to provide an input signal to a videogame or virtual element, to provide an input signal to another masturbation device (such as a phallic device), etc. Synchronous movement or motion between the penetration of the cap and movement of an external element, whether virtual or physical, is thereby provided.

As disclosed herein, an apparatus and method is provided that allows for fluctuating pressure inside a masturbation device to be detected. These fluctuations can be detected via a flexible diaphragm that is configured to prevent fluids from the interior of the masturbation device from entering a cap attached to the masturbation device. Data or information related to the fluctuating pressure can be used for additional features or aspects, such as use in a virtual videogame application, or to generate signals for an indicator that is attached or integrated with the cap. In another aspect, the cap operates on the principle of detecting fluctuating capacitance instead of pressure.

Throughout the disclosure, similar elements and components are indicated with similar reference numerals, and otherwise function in the same or similar manner and have the same or similar structures unless otherwise specified herein.

While specific embodiments are presented herein, other embodiments will be obvious to those skilled in the art. For example, in the case of the capacitance based cap, the cap can be extended to such that is surrounds a portion of the housing of the masturbation device, thereby improving the capacitance signal.

What is claimed is:

1. A cap configured to be attached to a masturbation device, the cap comprising:
at least one attachment element configured to selectively engage with the masturbation device;
at least one sealing element configured to provide a barrier relative to an interior of the masturbation device; and
at least one sensor configured to detect penetration of the masturbation device.

2. The cap according to claim 1, further comprising at least one processor configured to receive signals from the at least one sensor associated with penetration of the masturbation device.

3. The cap according to claim 2, further comprising at least one indicator element configured to be activated based on the signals from the at least one processor.

4. The cap according to claim 3, wherein the at least one indicator element includes a plurality of light emitting diodes (LEDs).

5. The cap according to claim 1, wherein the at least one attachment element comprises a threading configured to matingly engage with corresponding threading on the masturbation device.

6. The cap according to claim 1, wherein the at least attachment element comprises a flexible lip configured to engage an outer surface of a housing of the masturbation device.

7. The cap according to claim 1, wherein the at least one sensor is a pressure sensor.

8. The cap according to claim 7, wherein the at least one sealing element is a flexible diaphragm, and the pressure sensor is configured to detect penetration of the masturbation device based on fluctuations of the flexible diaphragm.

9. The cap according to claim 1, wherein the at least one sensor is a capacitance sensor.

10. The cap according to claim 9, wherein the capacitance sensor is configured to detect capacitance fluctuations based on penetration of the masturbation device.

11. The cap according to claim 9, wherein the masturbation device includes a conductive elastomeric gel insert within an outer housing.

12. The cap according to claim 1, further comprising a rechargeable battery.

13. The cap according to claim 1, wherein the cap is configured to transmit signals regarding penetration of the masturbation device such that the signals are used to actuate a phallic masturbation device.

14. The cap according to claim 1, wherein the cap is configured to transmit signals regarding penetration of the masturbation device to a processor and the signals are used to control a virtual element.

15. A cap configured to be attached to a masturbation device, the cap comprising:
at least one attachment element configured to selectively engage with the masturbation device such that the cap can be attached and detached from the masturbation device;
at least one sealing element configured to provide a barrier relative to an interior of the masturbation device;
at least one sensor configured to detect penetration of the masturbation device;
at least one processor configured to receive signals from the at least one sensor associated with penetration of the masturbation device;
at least one indicator element configured to be activated based on signals from the at least one sensor; and
a battery configured to power at least the at least one sensor, the at least one processor, and the at least one indicator element.

16. The cap according to claim 15, wherein the at least one sensor is a pressure sensor that is configured to detect pressure fluctuations within the masturbation device based on penetration of the masturbation device.

17. The cap according to claim 15, wherein the at least one sensor is a capacitance sensor configured to detect capacitance fluctuations based on penetration of the masturbation device.

18. The cap according to claim 15, wherein the at least one attachment element comprises a threading configured to matingly engage with corresponding threading on the masturbation device.

19. The cap according to claim 15, wherein the at least attachment element comprises a flexible lip configured to engage a housing of the masturbation device.

20. The cap according to claim 15, wherein the at least one processor is configured to wirelessly transmit data to a secondary processor, and the secondary processor is configured to control at least one virtual element based on the data.
